(19) United States
(12) Patent Application Publication
(10) Pub. No.: US 2024/0011914 A1
(43) Pub. Date: Jan. 11, 2024

(54) Method for Detecting Anomalies on a Surface of an Object

(71) Applicant: Robert Bosch GmbH, Stuttgart (DE)

(72) Inventors: Andreas Steimer, Schoemberg (DE); Christoph Begau, Bamberg (DE); Mehul Bansal, Sindelfingen (DE)

(21) Appl. No.: 18/349,355

(22) Filed: Jul. 10, 2023

(30) Foreign Application Priority Data
Jul. 11, 2022 (DE) 10 2022 207 070.4

(51) Int. Cl. G01N 21/88; G06N 20/00

(52) U.S. Cl. CPC G01N 21/88; G06N 20/00

(57) ABSTRACT

A method is for detecting anomalies on a surface of an object and includes creating a depth profile of the surface of the object, and pre-processing the depth profile by approximating a shape along a spatial dimension and subsequently subtracting the approximated shape from the depth profile in order to obtain a simplified profile. The method further includes detecting the anomalies on the surface of the object by applying a machine learning algorithm to the simplified profile. The machine learning algorithm is trained in order to detect anomalies in depth profiles.

This application claims priority under 35 U.S.C. § 119 to patent application no. DE 10 2022 207 070.4, filed on Jul. 11, 2022 in Germany, the disclosure of which is incorporated herein by reference in its entirety.

The disclosure relates to a method for detecting anomalies on a surface of an object, and in particular a method with which anomalies on a surface of an object can be detected reliably and with comparatively few computer resources.

### BACKGROUND

In the context of quality assurance during a manufacturing process, objects or components are typically subjected to an inspection after the actual manufacture, wherein a surface or a profile of the object is checked for the presence of deviations in relation to a standard or anomalies. Based on this inspection, it can then be decided, for example, whether the object in question is to be readily further processed or used, or else scrapped or disposed of, for example in order to avoid safety risks when the object is subsequently used.

Anomalies are understood here to mean abnormalities or irregularities formed on a surface of an object or irregularities or deviations compared to a specified standard include, for example scratches formed on the surface of a manufactured component or unwanted gaps or apertures formed between individual parts of the object.

In order to reliably enable such inspections and to render them independent of human perception skills, such methods for inspecting the surface of manufactured components are often based on machine learning algorithms. Machine learning algorithms are based on statistical methods being used to train a data processing system in such a way that it can perform a particular task without it being originally programmed explicitly for this purpose. The goal of machine learning is to construct algorithms that can learn and make predictions from data. These algorithms create mathematical models with which data can be classified, for example. In particular, the depth of the surface of the object can be measured or detected, and a depth profile of the surface of the object can be generated based on the individual measurement data, wherein the generated depth profile can then be evaluated, for example based on a correspondingly trained machine learning algorithm. The “depth profile” refers to a pattern or representation of measured depth data, i.e., measurement signals, or measured or detected elevations and depressions on the surface of the object.

However, it has proven disadvantageous that deviations from a standard due to production errors typically appear to be much smaller than the variations of a standard profile of the object in the depth profile, for which reason depth profiles of objects, in particular curved objects, are typically unsuitable as input variables for such algorithms of machine learning for detecting anomalies on surfaces of objects. A curved object is further understood to mean an object having a curved or bent surface, for example a circular or arcuate surface.

A method for contactless investigation and measurement of the surface contour of measured objects, in particular profile tubes with a laser measuring system, is known from the publication EP 1 241 439 A2, in which the measured object and the laser measuring system are moved linearly and rotationally relative to one another. In order to perform surface contour measurements on profile tubes during manufacturing, at least one laser sensor is guided in a plane transverse to the longitudinal axis of the profile tube, rotating about the profile tube, and, in the reflectance method, the distances from the laser sensor to the surface of the profile tube are measured, wherein the measured values together with the simultaneously captured information regarding the position of the laser sensor are supplied to a computer, in which a geometric surface contour is calculated from the measured values and compared to a target surface contour stored in the computer and displayed.

The disclosure thus addresses the problem of specifying an improved method for detecting anomalies on a surface of an object.

The problem is solved by a method for detecting anomalies on a surface of an object as disclosed herein.

The problem is further solved by a control unit for detecting anomalies on a surface of an object as disclosed herein.

The problem is additionally solved by a system for detecting anomalies on a surface of an object as disclosed herein.

### SUMMARY

According to one embodiment of the disclosure, this problem is solved by a method for detecting anomalies on a surface of an object, wherein the method comprises creating a depth profile of the surface of the object; pre-processing the depth profile, wherein the step of pre-processing the depth profile comprises approximating a shape along the spatial dimension and subsequently subtracting the approximated shape from the depth profile in order to obtain a simplified profile; and detecting anomalies on the surface of the object by applying a machine learning algorithm to the simplified profile, which algorithm is trained in order to detect anomalies in depth profiles.

The fact that the shape is averaged along the spatial dimension means that an average is formed from the repetitions of the individual raw shapes repeating along the spatial dimension.

The fact that the averaged shape or the formed average value is subsequently subtracted from the depth profile further means that the averaged shape, or ideally the raw shape that generates large signals, is subtracted from the generated depth profile, or the data underlying the depth profile, in each measurement or in each pixel row.

The signal remaining after subtraction of the signal generated by the averaged shape has a significantly improved visibility of deviations from the standard due to production errors, so that significantly less pre-processing and fewer computing resources, in particular memory and/or processor capabilities, are needed in order to evaluate the signals or data in question through the corresponding machine learning algorithm, and anomalies on the surface of the object can be reliably detected.

Overall, an improved method for detecting anomalies on a surface of an object is thus specified.

In one embodiment, the step of pre-processing the depth profile comprises an application of a principal component analysis.

The principal component analysis (PCA) is understood to mean a method of multivariate statistics whose goal is to extract the most important information from a data set and to express this information in the form of a smaller number of variables, the principal components, which explain a majority of the variance of the original data set. In particular, extensive data sets are structured using self-vectors of the covariance matrix, wherein the data sets can be simplified and illustrated by approximating a plurality of statistical variables with a smaller number of linear combinations that are as meaningful as possible.

The pre-processing, and in particular the determination of the raw shape or the average shape along the corresponding spatial dimension, can thus be based on known and common methods without the need for effort-intensive and costly restructurings.

The depth profile of the object can have, in particular, a constant or stereotypical shape along a spatial dimension. The fact that the depth profile of the object has a constant or stereotypical shape along a spatial dimension means that a shape of the depth profile in or along the corresponding direction or spatial dimension is substantially constant and, in particular, is based essentially on repetitions of a raw shape along the corresponding spatial dimension, or that the object is moved further accordingly.

The step of pre-processing the depth profile can further comprise a step of additionally simplifying the simplified profile by subtracting a plurality of principal components in order to obtain an additionally simplified profile, wherein the machine learning algorithm is subsequently applied to the additionally simplified profile.

The fact that several principal components are subtracted means that further principal components are subtracted from the depth profile or simplified profile.

As a result, an additional improvement of the useful signal or the signal processed by the machine learning algorithm can be achieved, whereby the detection of anomalies on the surface of the object can be further optimized or improved.

In a further embodiment, the step of pre-processing the depth profile comprises an application of a polynomial approximation.

Polynomial approximation is understood to mean a method for approaching or approximating functions in the vicinity of a point by a polynomial.

In this manner, the raw shape or a standard profile can be approximated in the spatial dimension, which can subsequently in turn be subtracted from the depth profile or corresponding signals.

The pre-processing, and in particular the determination of the raw shape or the average shape along the corresponding spatial dimension, can thus in turn be based on known and common methods without the need for effort-intensive and costly, i.e., resource-intensive, restructurings.

With a further embodiment of the disclosure, a method for discarding objects is specified, wherein the method comprises, for each of the objects, a respective detection of anomalies on the surface of the object in question through a method as described above for detecting anomalies on a surface of an object, a decision for each of the objects as to whether the object in question is to be discarded based upon anomalies detected on the surface of the object in question, and, for each of the objects, a respective discarding of the object in question if a decision has been made that it is to be discarded.

Thus, a method for discarding objects based on anomalies on the surface of the objects in question is specified, which is based on an improved method for detecting anomalies on a surface of an object.

In particular, insofar as a principal component analysis is used here, the method is based on a method for detecting anomalies on a surface of an object, in which the average of the invariant shape along the spatial dimension is subtracted from a measured depth profile, and wherein the signal remaining after subtraction of the signal generated by the averaged shape has a significantly improved detectability of deviations from the standard due to production errors, so that significantly fewer computing resources, in particular memory and/or processor capabilities, are needed in order to evaluate the signals or data in question through the corresponding machine learning algorithm, and anomalies on the surface of the object can be reliably detected.

With a further embodiment of the disclosure, a control unit for detecting anomalies on a surface of an object is specified, wherein the control unit comprises a provisioning unit configured so as to generate a depth profile of the surface of the object, a pre-processing unit configured so as to pre-process the depth profile, wherein the pre-processing of the depth profile comprises approximating a shape along the spatial dimension and then subtracting the approximated shape from the depth profile in order to obtain a simplified profile, and a detection unit configured so as to detect anomalies on the surface of the object by applying a machine learning algorithm to the simplified profile, which algorithm is trained in order to detect anomalies in depth profiles.

Thus, an improved control unit for detecting anomalies on a surface of an object is specified. The signal remaining after subtraction of the signal generated by the averaged shape has a significantly improved detectability of deviations from the standard due to production errors, so that significantly fewer computing resources, in particular memory and/or processor capabilities, are needed in order to evaluate the signals or data in question through the corresponding machine learning algorithm, and anomalies on the surface of the object can be reliably detected.

In one embodiment, the pre-processing unit is configured so as to apply a principal component analysis in order to pre-process the depth profile. The pre-processing, and in particular the determination of the raw shape or the average shape along the corresponding spatial dimension, can thus be based on known and common methods without the need for effort-intensive and costly restructurings.

The pre-processing unit can further be configured so as to further simplify the simplified profile by subtracting a plurality of principal components in order to obtain an additionally simplified profile, wherein the detection unit can be configured so as to apply the machine learning algorithm to the additionally simplified profile in order to detect anomalies on the surface of the object. As a result, an additional improvement of the useful signal or the signal processed by the machine learning algorithm can be achieved, whereby the detection of anomalies on the surface of the object can be further optimized or improved.

In a further embodiment, the pre-processing unit is configured so as to apply a polynomial approximation in order to pre-process the depth profile. The pre-processing, and in particular the determination of the raw shape or the average shape along the corresponding spatial dimension, can thus in turn be based on known and common methods without the need for effort-intensive and costly restructurings.

With a further embodiment of the disclosure, a system for detecting anomalies on a surface of an object is also specified, wherein the system comprises a measurement system for generating a depth profile of an object and a control unit, described above, for detecting anomalies on a surface of an object, and wherein the control unit is configured so as to process a depth profile generated by the measurement system in order to detect anomalies on a surface of the object in question.

A measurement system is understood to mean a generation unit, which is configured so as to measure depth data and to generate a depth profile based on the measured depth data. For example, the measuring system can be a laser measuring system, which is configured so as to generate a depth profile of a surface of an object moved linearly and rotationally around the measuring system.

Thus, an improved system for detecting anomalies on a surface of an object is specified. The signal remaining after subtraction of the signal generated by the averaged shape has a significantly improved detectability of deviations from the standard due to production errors, so that significantly fewer computing resources, in particular memory and/or processor capabilities, are needed in order to evaluate the signals or data in question through the corresponding machine learning algorithm, and anomalies on the surface of the object can be reliably detected.

With a further embodiment of the disclosure, a control unit for discarding objects is specified, wherein the control unit comprises a provisioning unit configured so as to provide, for each of the objects, information about anomalies on the surface of the object in question, wherein the information signifies anomalies detected by a control unit, described above, for detecting anomalies on a surface of an object, a decision-making unit configured so as to decide for each of the objects based on anomalies detected on the surface of the object in question whether the object in question is to be discarded, and a discarding unit configured so as to discard in each case the object in question if a decision has been made that it is to be discarded.

Thus, a control unit for discarding objects based on anomalies on the surface of the objects is specified, which is based on an improved control unit for detecting anomalies on a surface of an object. In particular, the control unit is based on a control unit for detecting anomalies on a surface of an object, which is configured so as to subtract the shape of the object along the spatial dimension from a measured depth profile, and wherein the signal remaining after subtraction of the signal generated by the averaged shape has a significantly improved detectability of deviations from the standard due to production errors, so that significantly fewer computing resources, in particular memory and/or processor capabilities, are needed in order to evaluate the signals or data in question through the corresponding machine learning algorithm, and anomalies on the surface of the object can be reliably detected.

In summary, with the disclosure, a method is specified for detecting anomalies on a surface of an object, and in particular a method with which anomalies on a surface of an object can be detected reliably and with comparatively few computer resources.

The described embodiments and developments can be combined with one another as desired.

Further possible embodiments, developments, and implementations of the disclosure also include not explicitly mentioned combinations of features of the disclosure described above or below with respect to exemplary embodiments.

### BRIEF DESCRIPTION OF THE DRAWINGS

The accompanying drawings are intended to provide a better understanding of the embodiments of the disclosure. They illustrate embodiments and, in connection with the description, serve to explain principles and concepts of the disclosure.

Other embodiments and many of the mentioned advantages will emerge with reference to the drawings. The shown elements of the drawings are not necessarily drawn to scale with respect to one another. Shown in the drawings are:

FIG. 1 a flow chart of a method for detecting anomalies on a surface of an object according to embodiments of the disclosure;

FIGS. 2A, 2B, and 2C a part of a method for detecting anomalies on a surface of an object according to a first embodiment of the disclosure;

FIGS. 3A and 3B a part of a method for detecting anomalies on a surface of an object according to a second embodiment of the disclosure; and

FIG. 4 a schematic block diagram of a control unit for detecting anomalies on a surface of an object according to embodiments of the disclosure.

### DETAILED DESCRIPTION

In the figures of the drawings, identical reference numerals denote identical or functionally identical elements, parts, or components, unless stated otherwise.

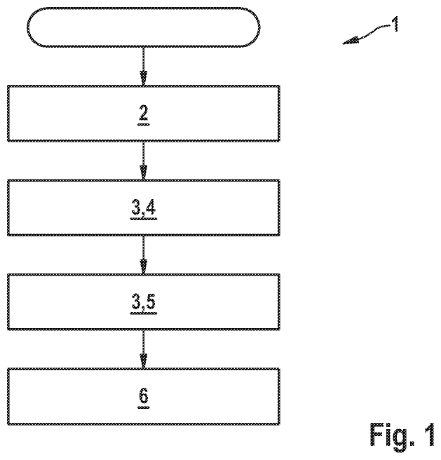

FIG. 1 shows a flow chart of a method for detecting anomalies on a surface of an object 1 according to embodiments of the disclosure.

In the context of quality assurance during a manufacturing process, objects or components are typically subjected to an inspection after the actual manufacture, wherein a surface or a profile of the object is checked for the presence of deviations in relation to a standard or anomalies. Based on this inspection, it can then be decided, for example, whether the object in question is to be readily further processed or used, or else scrapped or disposed of, for example in order to avoid safety risks when the object is subsequently used.

In order to reliably enable such inspections and to render them independent of human perception skills, such methods for inspecting the surface of manufactured components are often based on machine learning algorithms. In particular, the depth of the surface of the object can be measured or detected, and a depth profile of the surface of the object can be generated based on the individual measurement data, wherein the generated depth profile can then be evaluated, for example based on a correspondingly trained machine learning algorithm. The “depth profile” refers to a pattern or representation of measured depth data, i.e., measurement signals, or measured or detected elevations and depressions on the surface of the object.

However, it has proven disadvantageous that deviations from a standard due to production errors typically appear to be much smaller than the variations of a standard profile of the object in the depth profile, for which reason depth profiles of objects, in particular curved objects, are typically unsuitable as input variables for such algorithms of machine learning for detecting anomalies on surfaces of objects.

FIG. 1 shows a method for detecting anomalies on a surface of an object 1, wherein the method 1 comprises a step 2 of creating a depth profile of the surface of the object and a step 3 of pre-processing the depth profile, wherein the step 3 of pre-processing the depth profile comprises a step 4 of approximating a shape along the spatial dimension and a step 5 of subsequently subtracting the approximated shape from the depth profile in order to obtain a simplified profile. Furthermore, the method 1 comprises a step 6 of detecting anomalies on the surface of the object by applying a machine learning algorithm to the simplified profile, which algorithm is trained in order to detect anomalies in depth profiles.

The signal remaining after subtraction of the signal generated by the averaged shape has a significantly improved detectability of deviations from the standard due to production errors, so that significantly fewer computing resources, in particular memory and/or processor capabilities, are needed in order to evaluate the signals or data in question through the corresponding machine learning algorithm, and anomalies on the surface of the object can be reliably detected.

Overall, an improved method for detecting anomalies on a surface of an object 1 is thus given.

In particular, FIG. 1 shows a method 1 in which a repeating raw shape, which overlays the detected signals and is not of interest, is subtracted so that the remaining signal has a significantly better ratio of the variation of the component errors or anomalies to the overall variation of the signal.

The object can in particular be a curved object.

Step 2 of creating the depth profile can also comprise, for example, measuring the surface of the object by depth and/or relief measurements with a laser measuring system, wherein the object is moved linearly and rotationally around the laser measuring system, and subsequently generating a depth profile or a graphical representation of the individual measured values or signals, wherein profile image data is generated, which subsequently serves as an input variable for the machine learning algorithm.

The machine learning algorithm can further be, for example, an artificial neural network.

The machine learning algorithm can also have been trained on, for example, correspondingly labeled comparative data and/or historical data or known anomalies and associated and/or assigned depth data.

The anomalies detected by the method 1 can then be evaluated, wherein it can be decided based on the detected anomalies whether, for example, the manufactured object or component is to be discarded, wherein a discarding system, which is part of the quality assurance and which is configured so as to automatically discard objects based on given anomalies or deviations from the standard, can be actuated accordingly.

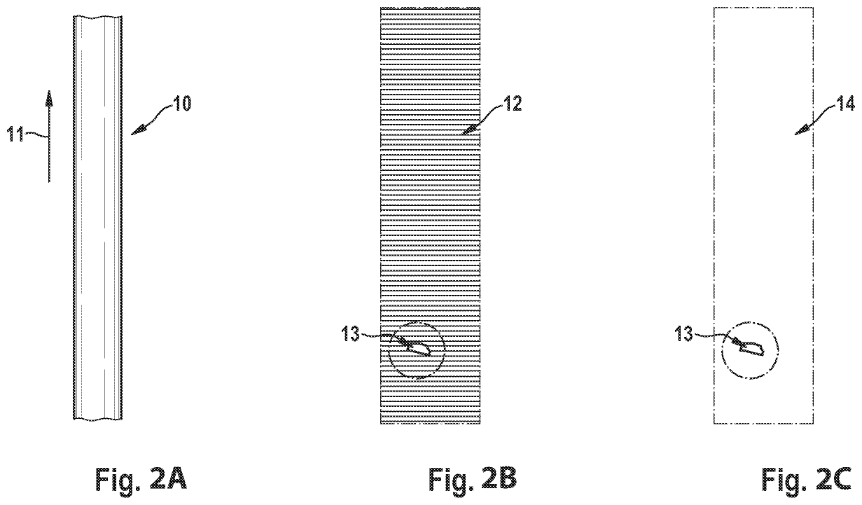

FIGS. 2A to 2C illustrate a part of a method for detecting anomalies on the surface of an object according to a first embodiment.

In particular, FIGS. 2A to 2C illustrate the step of pre-processing the depth profile according to a first embodiment.

According to the first embodiment, the manufactured object is a well, which can be installed in a combustion engine, for example.

FIG. 2A shows the generated depth profile 10 or a profile generated based on raw data detected by depth measurements.

The depth profile 10 shown in FIG. 2A was in particular generated in that the well, which has a hemispherical shape, was rotated in front of a laser measuring system or a laser measuring camera during the depth measurements, thereby creating the semi-cylindrical standard profile shown.

In particular, the depth profile 10 shown in FIG. 2A has a stereotypical shape, which is a semicircle according to the first embodiment, repeating along a spatial dimension, which is symbolized in FIG. 2A by the arrow bearing the reference numeral 11.

According to the first embodiment, the depth profile 10 shown in FIG. 2A is in turn pre-processed, so that significantly fewer computer resources, in particular memory and/or processor capacities, are required in order to evaluate the signals or data in question with the corresponding machine learning algorithm, and anomalies on the surface of the object can be reliably detected.

According to the first embodiment, the step of pre-processing the depth profile comprises applying a principal component analysis.

In particular, the originally detected three-dimensional raw measurement data and/or the originally generated depth profile can be split into an x, y, and z fraction or into a fraction for each spatial dimension in such a way that the respective one measurement signal y(x) represents the depth profile as a function of x for the principal component analysis, wherein the number of pixels along a spatial dimension x represents the dimension of the vector space, and wherein the numeric values of the vector components are given by y or represented in a further spatial dimension. The number of pixels along the third spatial dimension, or a corresponding z-axis along which the depth profile remains approximately constant, further determines the number of vectors or the number of training examples for the principal component analysis. The corresponding, repetitively occurring raw shape can be considered a zeroth component of the principal component analysis.

According to the first embodiment, the step of pre-processing the depth profile additionally comprises a step of additionally simplifying the simplified profile by subtracting a plurality of principal components in order to obtain an additionally simplified profile, wherein the machine learning algorithm is applied to the additionally simplified profile.

FIG. 2B shows a simplified profile 12, which was generated by subtracting the zeroth principal component and the first principal component from the depth profile 10.

As FIG. 2B shows, small non-linearities or distortions in the z-direction or along the spatial dimension 11 have been filtered out and the edges of the depth profile 10 have also been cut off.

As FIG. 2B further shows, an anomaly 13 can now be seen, which, however, can still be overlain by a periodic light/dark structure generated due to an artifact of the depth measurement.

FIG. 2C further shows an additionally simplified profile 14, which is generated by additional subtraction of the second principal component and the third principal component from the simplified profile 12.

As can be seen, the artifact has now disappeared, so that the anomaly 13 or the corresponding defect can be seen even more clearly.

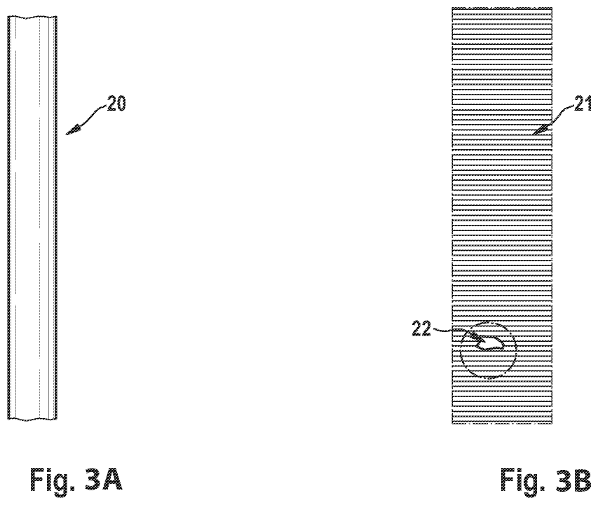

FIGS. 3A and 3B illustrate a part of a method for detecting anomalies on the surface of an object according to a second embodiment.

In particular, FIGS. 3A and 3B illustrate the step of pre-processing the depth profile according to a second embodiment.

FIG. 3A in turn shows a depth profile 20 of a surface of a well generated by depth measurements.

The difference between the first embodiment shown in FIGS. 2A to 2C and the second embodiment shown in FIGS. 3A and 3B is that the pre-processing of the depth profile 20 according to the second embodiment comprises an application of a polynomial approximation.

In particular, a raw measurement signal y can be approximated to x and z, respectively the other two spatial dimensions, by compensatory calculation, for example on the basis of a bivariant spline function with a suitable number of support points, in order to obtain an idealized representation of the recurring standard profile or the recurring raw shape, which is subsequently subtracted from the raw measurement data or the raw measurement signal.

FIG. 3B shows a simplified profile 21, which has been generated by corresponding subtraction of the idealized standard profile from the raw measurement signal, wherein anomalies 22 can again be seen.

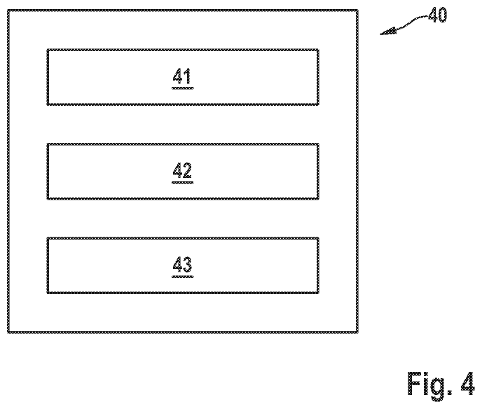

FIG. 4 shows a control unit for detecting anomalies on a surface of an object 40 according to embodiments of the disclosure.

In particular, FIG. 4 shows a control unit for detecting anomalies on a surface of an object 40.

As FIG. 4 shows, the control unit 40 comprises a provisioning unit 41 configured so as to generate a depth profile of the surface of the object, a pre-processing unit 42 configured so as to pre-process the depth profile, wherein the pre-processing of the depth profile comprises approximating a shape along the spatial dimension and then subtracting the approximated shape from the depth profile in order to obtain a simplified profile, and a detection unit 43 configured so as to detect anomalies on the surface of the object by applying a machine learning algorithm to the simplified profile, which algorithm is trained in order to detect anomalies in depth profiles.

The provisioning unit can in particular be a receiver configured so as to receive data from a corresponding measurement system, for example a laser measuring system, or a sensor for measuring depth data with a corresponding evaluation unit. The pre-processing unit and the detection unit can furthermore respectively be implemented, for example, based on a code that is stored in a memory and can be executed by a processor.

According to the embodiments of FIG. 4, pre-processing unit 42 is configured so as to apply a principal component analysis in order to pre-process the depth profile.

The pre-processing unit 42 is also configured so as to further simplify the simplified profile by subtracting a plurality of principal components in order to obtain an additionally simplified profile, wherein the detection unit 43 is configured so as to apply the machine learning algorithm to the additionally simplified profile in order to detect anomalies on the surface of the object.

Again, the object can in particular be a curved object.

What is claimed is:

1. A method for detecting anomalies on a surface of an object, the method comprising:
creating a depth profile of the surface of the object;
pre-processing the depth profile by approximating a shape along a spatial dimension and subsequently subtracting the approximated shape from the depth profile in order to obtain a simplified profile; and
detecting the anomalies on the surface of the object by applying a machine learning algorithm to the simplified profile, the machine learning algorithm trained in order to detect anomalies in depth profiles.

2. The method according to claim 1, wherein the pre-processing the depth profile includes applying a principal component analysis.

3. The method according to claim 2, wherein:
the pre-processing the depth profile further includes additionally simplifying the simplified profile by subtracting a plurality of principal components of the principal component analysis in order to obtain an additionally simplified profile, and
the machine learning algorithm is applied to the additionally simplified profile in order to detect the anomalies.

4. The method according to claim 1, wherein the pre-processing the depth profile includes applying a polynomial approximation.

5. The method according to claim 1, wherein:
a controller is configured to perform the method, and
the controller is configured to implement:
a provisioning unit configured so as to provide the depth profile of the surface of the object,
a pre-processing unit configured to pre-process the depth profile, and
a detection unit configured to detect the anomalies on the surface of the object by applying the machine learning algorithm to the simplified profile.

6. The method according to claim 5, wherein the pre-processing unit is configured to apply a principal component analysis in order to pre-process the depth profile.

7. The method according to claim 6, wherein:
the pre-processing unit is configured to further simplify the simplified profile by subtracting a plurality of principal components of the principal component analysis in order to obtain an additionally simplified profile, and
the detection unit is configured to apply the machine learning algorithm to the additionally simplified profile in order to detect the anomalies.

8. The method according to claim 5, wherein the pre-processing unit is configured to apply a polynomial approximation in order to pre-process the depth profile.

9. A method for discarding objects of a plurality of objects, comprising:
for each object of the plurality of objects, respectively detecting anomalies on a surface of the object in question by:
creating a depth profile of the surface of the object,
pre-processing the depth profile by approximating a shape along a spatial dimension and subsequently subtracting the approximated shape from the depth profile in order to obtain a simplified profile, and
detecting the anomalies on the surface of the object by applying a machine learning algorithm to the simplified profile, the machine learning algorithm trained in order to detect anomalies in depth profiles;
for each object of the plurality of objects, respectively determining whether the object in question is to be discarded based on the anomalies detected on the surface of the object; and
for each object of the plurality of objects, respectively discarding the object in question when it has been determined that the object in question is to be discarded.

10. A system for detecting anomalies on a surface of an object, comprising:
a measurement system configured to generate a depth profile of the object; and
a controller operably connected to the measurement system and configured to detect the anomalies on the surface of the object, the controller configured to implement:
a provisioning unit configured to provide the depth profile of the surface of the object,
a pre-processing unit configured to pre-process the depth profile, and
a detection unit configured to detect the anomalies on the surface of the object by applying a machine learning algorithm to the simplified profile,
wherein the controller is configured to process the depth profile generated by the measurement system in order to detect the anomalies on the surface of the object.
